(19) United States
(12) Patent Application Publication
(10) Pub. No.: US 2003/0202522 A1
(43) Pub. Date: Oct. 30, 2003

(54) System for concurrent distributed processing in multiple finite state machines

(76) Inventor: Ping Jiang, Dover, DE (US)

Correspondence Address: PATTON BOGGS, PO BOX 270930, LOUISVILLE, CO, 80027, US

(21) Appl. No.: 10/131,759

(22) Filed: Apr. 24, 2002

(51) Int. Cl. H04L 12/28

(52) U.S. Cl. 370/401; 370/419

(57) ABSTRACT

The system for concurrent distributed processing in multiple finite state machines uses the paradigm of non-blocking client-server models, where the finite state machines are concurrently operable to process the required tasks in a distributed manner. In addition to the ability to handle multiple concurrently received tasks, the system serves multiple clients that run on different operating environments on different machines that are interconnected via a Local Area Network. The requests are processed in different processes/threads/tasks depending on the operating environment in which finite state machine clients and the finite state machine server are running. The overall processing system can be provisioned to meet different networked computing environments and can be tuned to optimize performance. A plurality of finite state machine processing clients are each processed in a processing environment connected to a Local Area Network, which is a finite state machine processing server engine executes. The finite state machine processing server engine activates a plurality of child processes, each of which serves a designated finite state machine processing client.

### FIELD OF THE INVENTION

This invention relates to finite state machines and in particular to the concurrent operation of multiple finite state machines.

Problem

It is a problem in the field of finite state machines, configured as a group of processors located in a system, to enable the concurrent processing of tasks and the execution of program instructions in multiple operating environments.

Finite state machines are widely used in the computer and network industries. However, existing system and network architectures that are implemented in these industries rely on the use of single thread processing where the collection of finite state machines operate on a single thread or execute a single process in a single, uniform operating environment. In this architecture, each finite state machine receives inputs (such as triggers), processes the received inputs, then generates one or more outputs, which may be transmitted to the next finite state machine in the series of finite state machines. Once this cycle is completed, the finite state machine that has completed its execution of its assigned task waits for the next set of inputs to be received. This form of sequential processing is a single thread sequential process that is limited to receiving and processing a single request at a time. This limitation renders the overall system operation slow and also limits the processing to a single operating environment. There is another problem with this architecture in that it is susceptible to a single point of failure where the disabling of a single finite state machine in the series of finite state machines disables the entire sequence.

U.S. Pat. No. 6,252,879 discloses a multi-port bridge that includes a plurality of ports that are interconnected by a communication bus. Each port includes: a first finite state machine which controls the receipt of data packets from the memory and transmits data packets to the network, a second finite state machine which controls the receipt of memory pointers from the communication bus and stores these pointer in a buffer memory, and a third finite state machine which controls the receipt of packets from the network and stores the received packets in the memory. The finite state machines can be concurrently operating, since they each perform separate and independent operations, but each finite state machine is constrained to the single operating environment and the overall task is parsed into individual discrete subtasks that are executed by the series of interconnected finite state machines.

U.S. Pat. No. 6,208,623 discloses a method of enabling legacy networks to operate in a network environment that implements a new routing and signaling protocol. If two nodes in the network are of like protocol, a standard operation is permitted. If the two nodes in the network operate using dissimilar protocols, then the finite state machines in the two nodes are adapted to execute a modified protocol that entails a minimal protocol set that represents a consistent communication set. In this manner, the finite state machines are capable of executing either the standard protocol or a minimal protocol set from another protocol.

These above-noted systems all rely on the use of single thread processing, where the collection of finite state machines operate on a single thread or execute a single process in a single, uniform operating environment. In this architecture, each finite state machine receives inputs (such as triggers), processes the received inputs, then generates one or more outputs, which may be transmitted to the next finite state machine in the series of finite state machines. Once this cycle is completed, the finite state machine that has completed its execution of its assigned task waits for the next set of inputs to be received. This form of sequential processing is a single thread sequential process that is limited to receiving and processing a single request at a time.

Solution

The above described problems are solved and a technical advance achieved by the system for concurrent distributed processing in multiple finite state machines which uses a client-server model to enable concurrent distributed processing multiple finite state machines. The overall processing system can be provisioned to meet different networked computing environments and can be tuned to optimize performance.

The system for concurrent distributed processing in multiple finite state machines uses the paradigm of non-blocking client-server models, where the finite state machines are concurrently operable to process the required tasks in a distributed manner. In addition to the ability to handle multiple concurrently received tasks, the system serves multiple processing clients that run on different operating environments on different machines that are interconnected via a Local Area Network. The operation is processed in different processes/threads/tasks depending on the operating environment in which finite state machine clients and the finite state machine server are running. The overall processing system can be provisioned to meet different networked computing environments and can be tuned to optimize performance. A plurality of finite state machine processing clients are processed in a processing environment connected to a Local Area Network, which is also connected to a processing environment in which a finite state machine processing server engine executes. The finite state machine processing server engine activates a plurality of child processes, each of which serves a designated finite state machine processing client. Both the finite state machine processing clients and the finite state machine processing server engine need a TCP/IP stack to implement this method and most operating systems support the TCP/IP stack. Each processing client can be independent of the other processing clients with inter-client communications being implemented by means of inter-process/inter-thread/inter-task communication processes. By using proper conditional compilation, a system can be developed to be independent of the operating environment.

### BRIEF DESCRIPTION OF THE DRAWINGS

FIG. 1 illustrates in block diagram form the overall architecture of the system for concurrent distributed processing in multiple finite state machines; and

FIGS. 2 & 3 illustrate in flow diagram form the operation of the system for concurrent distributed processing in multiple finite state machines as viewed from the client and server side, respectively.

### DETAILED DESCRIPTION OF THE DRAWINGS

The system for concurrent distributed processing in multiple finite state machines uses the paradigm of non-blocking client-server models, where the finite state machines are processed in processing environments connected by a Local Area Network and are concurrently operable to process the required tasks in a distributed manner. The service requests are processed in different processes/threads/tasks depending on the operating environment in which finite state machine clients and the finite state machine server are running. A processing environment, in which a finite state machine processing server engine executes, is also connected to the Local Area Network. The finite state machine processing server engine activates a plurality of child processes, each of which serves a designated finite state machine processing client. Both the finite state machine processing clients and the finite state machine processing server engine use a TCP/IP stack. Each processing client can be independent of the other processing clients and can communicate with the server engine by means of inter-process/inter-thread/inter-task communication mechanisms based on different operating environments.

Architecture of the System for Concurrent Distributed Processing

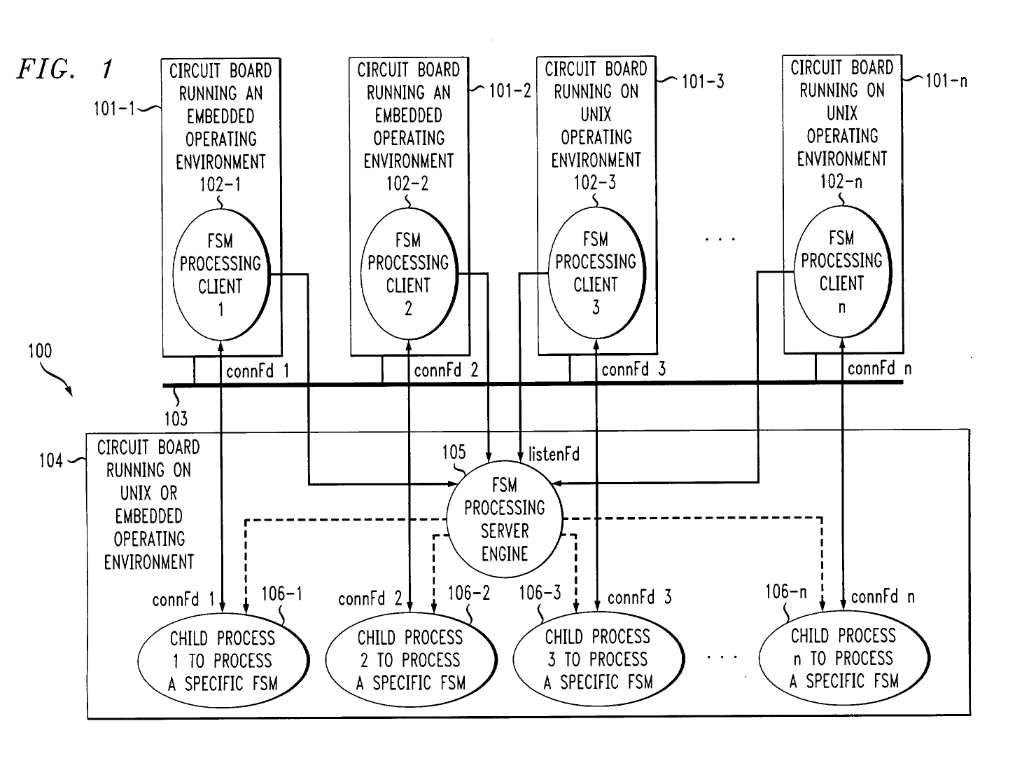

FIG. 1 illustrates in block diagram form the overall architecture of the system for concurrent distributed processing in multiple finite state machines 100, wherein a plurality of finite state machine processing clients 102-1 to 102-n, each executing in an associated operating environment 101-1 to 101-n, are connected to a Local Area Network 103. The plurality of finite state machine processing clients 102-1 to 102-n each execute one or more predetermined tasks and transmit data to and receive data from a finite state machine processing server engine 105. The Local Area Network 103 is also connected to a processing environment 104 in which the finite state machine processing server engine 105 executes. The finite state machine processing server engine 105 responds to requests received from the various finite state machine processing clients 102-1 to 102-n by creating an associated child process 106-1 to 106-n to execute the process requested by the associated finite state machine processing client 102-1 to 102-n.

The operating environments 101-1 to 101-n can be various circuit implementations, which run on an embedded operating environment, a UNIX operating environment, and the like. The finite state machine processing server engine 105 resides in its own operating environment, such as an embedded operating environment or a UNIX operating environment, and activates a plurality of child processes 106-1 to 106-n, each of which serves a designated one of the finite state machine processing clients 102-1 to 102-n. In the system for concurrent distributed processing in multiple finite state machines 100, service requests, designated by unidirectional solid arrows on FIG. 1, originate in finite state machine processing clients 102-1 to 102-n and are directed via the Local Area Network 103 to the listenFd process that executes in the finite state machine processing server engine 105. The finite state machine processing server engine 105 creates new processes/threads/tasks by spawning child processes, as indicated by the dotted arrow in FIG. 1. The finite state machine processing clients 102-1 to 102-n and the plurality of child processes 106-1 to 106-n communicate via the Local Area Network 103, using socket connections connFd1-connFdn.

Depending upon the operating environment, the finite state machine processing server engine 105 can be implemented in different ways, using: multi-processing, multi-threading, or multi-tasking. For example, in a UNIX networking environment, there are two ways the finite state machine processing server engine 105 can be implemented:

a. Using multi-processing—system calls such as fork( ), exec( ) can be used to generate multiple processes.

b. Using multi-threading—the thread library, such as pthread_create( ), pthread_join( ), pthread_detach( ), pthread_exit( ), can be used to generate multiple threads.

In a real time operating environment, the finite state machine processing server engine 105 can be implemented:

c. Using multi-tasking—In a VxWorks environment, taskLib library, such as taskSpawn( ), taskDelete( ), taskSuspend( ), functions can be used to implement the multi-task processing. In pSOS environment, system calls, such as t_create( ), t_delete( ), and the like, can be used to implement the multi-task processing.

Finite state machine server engine 105 and finite state machine processing clients 102-1 to 102-n can be implemented using selects system calls, which are supported by most operating environments. Both the finite state machine processing clients 102-1 to 102-n and the finite state machine processing server engine 105 use a TCP/IP stack and most operating systems support the TCP/IP stack. Each processing client 102-1 to 102-n is independent to other clients. Using proper conditional compilation, the system for concurrent distributed processing in multiple finite state machines 100 can be independent of the operating environment. The finite state machine processing clients 102-1 to 102-n and the finite state machine processing server engines 105 can execute in different operating environments as long as they are interconnected via a Local Area Network 103.

Operation of the System for Concurrent Distributed Processing—Client Side

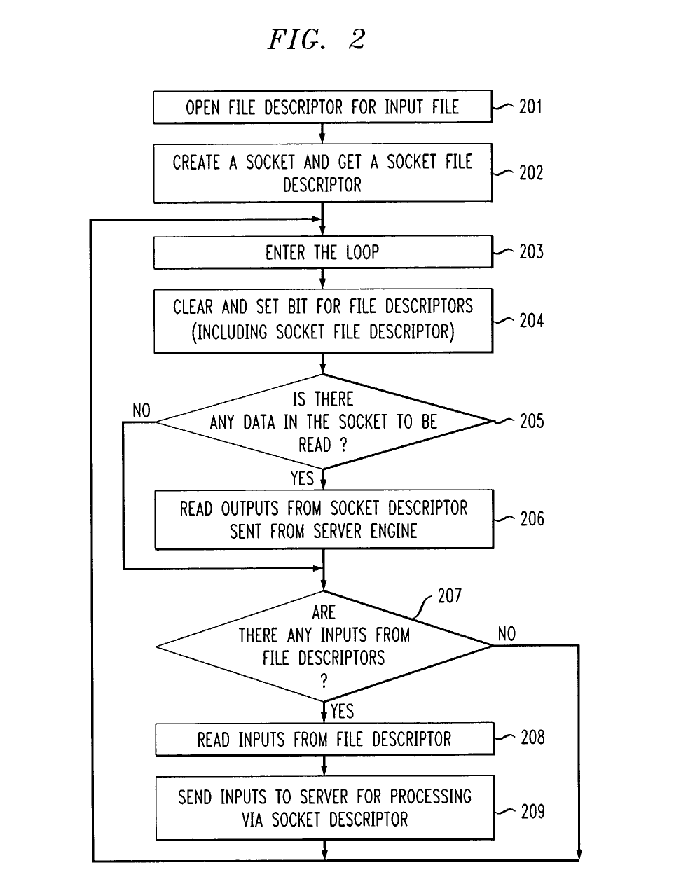

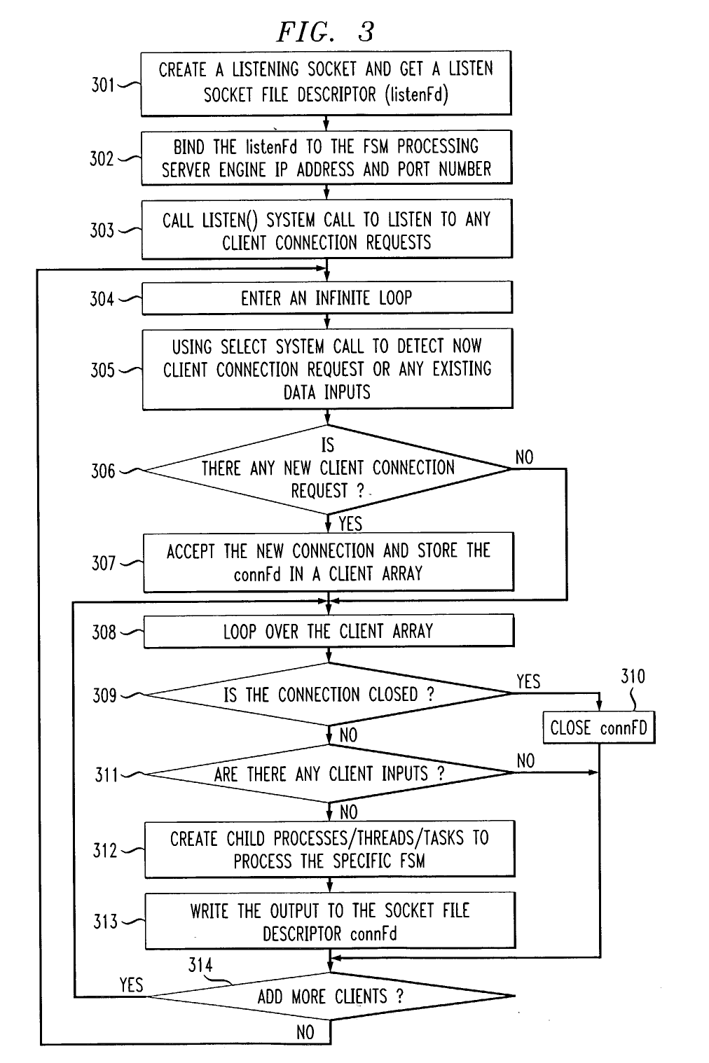

FIGS. 2 & 3 illustrate in flow diagram form the operation of the system for concurrent distributed processing in multiple finite state machines 100 as viewed from the client and server side, respectively. On the client side, each finite state machine processing client 102-1 to 102-n opens an input/output file descriptor for an input/output file at step 201, creates a socket and obtains a socket file descriptor at step 202. The socket file descriptor is used by the finite state machine processing client 102-1 to 102-n along with the finite state machine processing server engine's IP addresses and port numbers to connect the finite state machine processing client 102-1 to 102-n to the finite state machine processing server engine 105 via the Local Area Network 103. Each finite state machine processing client 102-1 to 102-n enters into a loop at step 203, which runs until the finite state machine processing stops. At step 204, the finite state machine processing client 102-1 to 102-n clears and sets the flag bits for the file descriptors, including the socket file descriptor. During the execution of the steps contained within the loop, at step 205 each finite state machine processing client 102-1 to 102-n checks to see if there is any data in the socket file descriptors, to indicate that there are inputs, received from the finite state machine processing server engine 105, to be read in a non-blocking way. If there are outputs from the finite state machine processing server engine 105, the finite state machine processing client 102-1 to 102-n read the data sent from server engine 105 at step 206 and advances to step 207. If there are no outputs from the finite state machine processing server engine 105 at step 205, the finite state machine processing client 102-1 to 102-n advances to step 207.

At step 207, each finite state machine processing client 102-1 to 102-n checks its input file descriptors to see if there are any inputs in the finite state machine processing client 102-1 to 102-n to be transmitted to the finite state machine server engine 105 via sockets in a non-blocking way. If there are inputs from the finite state machine processing client 102-1 to 102-n , the finite state machine processing client 102-1 to 102-n reads inputs at step 208 and sends inputs to the finite state machine server engine 105 via socket file descriptor at step 209. If there are no inputs from file descriptors, the finite state machine processing client 102-1 to 102-n proceeds to step 209.

The processing returns to step 203 and the above-noted steps are repeated until processing is completed.

Operation of the System for Concurrent Distributed Processing—Server Side

From the server side, the finite state machine processing server engine 105 creates a socket, termed listenFd, at step 301 for listening to any finite state machine processing client connection request that is received over the Local Area Network 103. The finite state machine processing server engine 105 binds the listenFd with the finite state machine processing server engine IP address and port number at step 302. The finite state machine processing server engine 105 listens at step 303 to each finite state machine processing client connection request using listenFd and enters into an infinite loop at step 304.

During this infinite loop, the finite state machine processing server engine 105 uses the select system call, or an equivalent command, at step 305 to search for new connection requests received from the finite state machine processing clients 102-1 to 102-n and any existing data inputs that have not been processed. If there is a new connection request received from the finite state machine processing clients 102-1 to 102-n as determined at step 306, the finite state machine processing server engine 105 connects to the finite state machine processing client 102-1 to 102-n and obtains a connection file descriptor, termed connFd at step 307 and advances to step 308. If no new connection request is received from the finite state machine processing clients 102-1 to 102-n as determined at step 306, the finite state machine processing server engine 105 advances to step 308.

At step 308, the finite state machine processing server engine 105 begins a processing loop that executes across all of the finite state machine processing clients 102-1 to 102-n. At step 309, the finite state machine processing server engine 105 selects one of the finite state machine processing clients 102-1 to 102-n and determines whether the socket connection between the selected finite state machine processing clients 102-1 to 102-n and the finite state machine processing server engine 105 is closed. If so, processing advances to step 310 where the finite state machine processing server engine 105 closes its portion of the socket connection and terminates the associated child process/thread/task 106-1 to 106-n. If the socket connection between the selected finite state machine processing clients 102-1 to 102-n and the finite state machine processing server engine 105 is open, the finite state machine processing server engine 105 stores the connFd in its array that identifies the finite state machine processing clients 102-1 to 102-n and then checks at step 311 to see if there is any input from the finite state machine processing client 102-1 to 102-n. If there is, the finite state machine processing server engine 105 creates a child process/thread/task 106-1 to 106-n at step 312 to process a specific finite state machine and transmit the output to the finite state machine processing client through the connFd socket at step 313.

At step 314, the finite state machine processing server engine 105 determines whether additional finite state machine processing clients 102-1 to 102-n remain to be processed and, if so, processing returns to step 308. Once all of the finite state machine processing clients 102-1 to 102-n have been served, processing returns to step 304.

### SUMMARY

The system for concurrent distributed processing in multiple finite state machines uses a plurality of finite state machine processing clients that are each processed in a processing environment connected to a Local Area Network, which is also connected to a processing environment in which a finite state machine processing server engine executes. The finite state machine processing server engine activates a plurality of child processes, each of which serves a designated finite state machine processing client.

What is claimed:

1. A system for concurrent distributed processing in multiple finite state machines comprising:
a plurality of finite state machine processing client means, each operable to execute at least one task;
at least one finite state machine processing server engine means, executing in a first operating environment, for processing data received from said plurality of finite state machine processing client means; and
a local area network means connected to and interconnecting said plurality of finite state machine processing client means and said at least one finite state machine processing server engine means.

2. The system for concurrent distributed processing in multiple finite state machines of claim 1 further comprising:
a plurality of child processes, executing in said first operating environment, for processing data received from an associated on of said plurality of finite state machine processing client means via said local area network means.

3. The system for concurrent distributed processing in multiple finite state machines of claim 2 further comprising:
listen process means, connected to said local area network means for monitoring receipt of data transmitted to said at least one finite state machine processing server engine means by one of said plurality of finite state machine processing client means.

4. The system for concurrent distributed processing in multiple finite state machines of claim 3 further comprising:
child process management means for originating a one of said plurality of child processes in response to an associated one of said plurality of finite state machine processing client means transmitting data to said at least one finite state machine processing server engine means.

5. The system for concurrent distributed processing in multiple finite state machines of claim 3 further comprising:

6. The system for concurrent distributed processing in multiple finite state machines of claim 1 further comprising:
a plurality of operating environments each operable to enable execution of a one of said plurality of finite state machine processing client means.

7. The system for concurrent distributed processing in multiple finite state machines of claim 6 wherein said plurality of operating environments include multiple types of operating environments.
